(19) United States
(12) Patent Application Publication
(10) Pub. No.: US 2025/0271777 A1
(43) Pub. Date: Aug. 28, 2025

(54) DETERMINING AN OPTIMAL CONFIGURATION FOR A METROLOGY SYSTEM

(71) Applicant: Lumentum Operations LLC, San Jose, CA (US)

(72) Inventors: Alan HNATIW, Stittsville (CA); Daniel BURKE, Vars (CA)

(21) Appl. No.: 18/629,782

(22) Filed: Apr. 8, 2024

Related U.S. Application Data
(60) Provisional application No. 63/558,382, filed on Feb. 27, 2024.

(51) Int. Cl. G03F 7/00; G06F 30/20; G06F 119/10

(52) U.S. Cl. CPC G03F 7/706833; G03F 7/706837; G03F 7/706839; G06F 30/20; G06F 2119/10

(57) ABSTRACT

In some implementations, a metrology optimization system may obtain three-dimensional (3D) model information associated with an object. The metrology optimization system may obtain optical sensor information associated with a metrology system that is to measure the object. The metrology optimization system may determine, based on the 3D model information and the optical sensor information, an initial configuration for the metrology system. The metrology optimization system may determine, based on the 3D model information, the optical sensor information, and the initial configuration, an optimal configuration for the metrology system. The metrology optimization system may provide the optimal configuration for the metrology system.

### CROSS-REFERENCE TO RELATED APPLICATION

This Patent application claims priority to U.S. Patent Application No. 63/558,382, filed on Feb. 27, 2024, and entitled “OPTIMIZING INTEGRATION TIMES OF AN OPTICAL SCANNER.” The disclosure of the prior Application is considered part of and is incorporated by reference into this Patent Application.

### TECHNICAL FIELD

The present disclosure relates generally to metrology and to determining configuration parameters for a metrology system.

### BACKGROUND

An optical metrology system utilizes light to measure various physical properties, such as shape, size, or texture, of an object or features of an object.

### SUMMARY

In some implementations, a method includes obtaining, by a metrology optimization system, three-dimensional (3D) model information associated with an object; obtaining, by the metrology optimization system, optical sensor information associated with a metrology system that is to measure the object; determining, by the metrology optimization system and based on the 3D model information and the optical sensor information, an initial configuration for the metrology system; determining, by the metrology optimization system and based on the 3D model information, the optical sensor information, and the initial configuration, an optimal configuration for the metrology system; and providing, by the metrology optimization system, the optimal configuration for the metrology system.

In some implementations, a metrology optimization system includes one or more memories; and one or more processors, coupled to the one or more memories, configured to: determine, based on 3D model information associated with an object and optical sensor information associated with a metrology system that is to measure the object, an initial configuration for the metrology system; determine, based on the 3D model information, the optical sensor information, and the initial configuration, an optimal configuration for the metrology system; and provide the optimal configuration for the metrology system.

In some implementations, a non-transitory computer-readable medium storing a set of instructions includes one or more instructions that, when executed by one or more processors of a metrology optimization system, cause the metrology optimization system to: determine, based on 3D model information associated with an object and optical sensor information associated with a metrology system that is to measure the object, an optimal configuration for the metrology system; and provide the optimal configuration for the metrology system.

### BRIEF DESCRIPTION OF THE DRAWINGS

FIGS. 1A-1F are diagrams of an example implementation associated with determining an optimal configuration for a metrology system.

FIG. 2 is a diagram of an example environment in which systems and/or methods described herein may be implemented.

FIG. 3 is a diagram of example components of a device associated with determining an optimal configuration for a metrology system.

FIG. 4 is a flowchart of an example process associated with determining an optimal configuration for a metrology system.

### DETAILED DESCRIPTION

The following detailed description of example implementations refers to the accompanying drawings. The same reference numbers in different drawings may identify the same or similar elements.

A metrology system can be used to measure a three-dimensional (3D) geometry (e.g., a 3D shape, texture, or other physical characteristic) of an object by utilizing optical analysis techniques, such as techniques associated with structured light, direct time of flight, indirect time of flight, and frequency chirping. Positioning optical sensors of the metrology system to measure an object involves several complexities due to a need for accurately measuring the object, a need for comprehensively measuring the object, and a need for efficiently measuring the object, among other examples. It is often difficult to achieve an effective configuration of the metrology system without using an extensive configuration routine, which can require multiple physical adjustments and testing of the optical sensors of the metrology system.

Some implementations described herein include a metrology optimization system that obtains 3D model information associated with an object and optical sensor information (e.g., that indicates capabilities and settings of the optical sensors) associated with a metrology system that is to measure the object. The metrology optimization system determines an initial configuration of the metrology system (e.g., an initial placement of optical sensors, such as one sensor per “side” of the object) and then determines an optimal configuration for the metrology system (e.g., that indicates an optimal placement and optimal integration times of the optical sensors). The optimal configuration is then provided to the metrology system to allow the optical sensors of the metrology system to be configured according to the optimal configuration.

In this way, the optimal configuration allows the metrology system to accurately and to comprehensively measure the object (e.g., using an optimal number of optical sensors placed in optimal positions and orientations) and to measure the object efficiently (e.g., integration times associated with points of field of views (FOVs) of the optical sensors are less than a threshold amount of time). Also, by providing an optimal configuration for a static placement of the optical sensors, there is no need for dynamic movement of the optical sensors (e.g., on a robotic arm, or another means for physically moving the optical sensors), which further improves accuracy and efficiency of the metrology system.

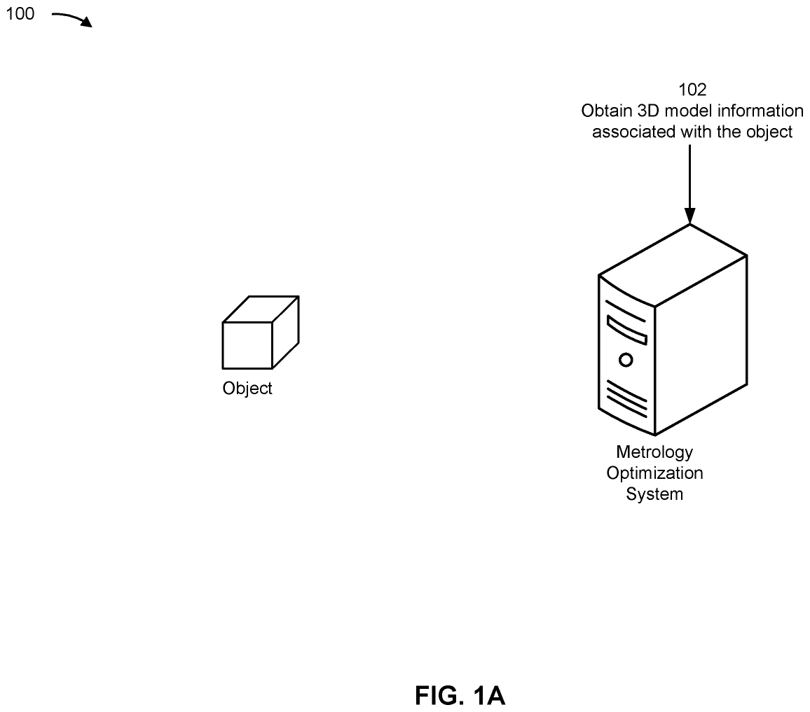

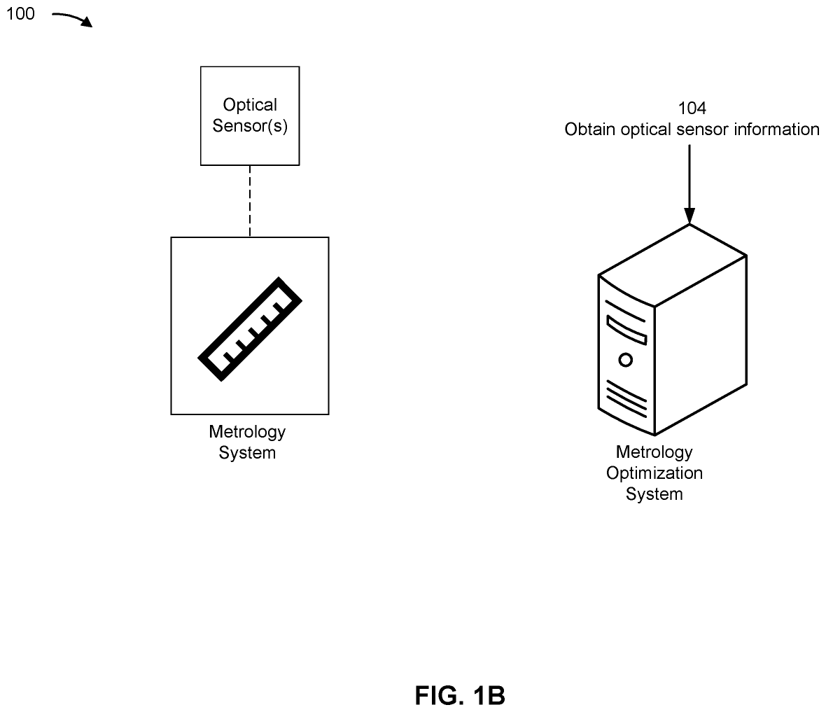

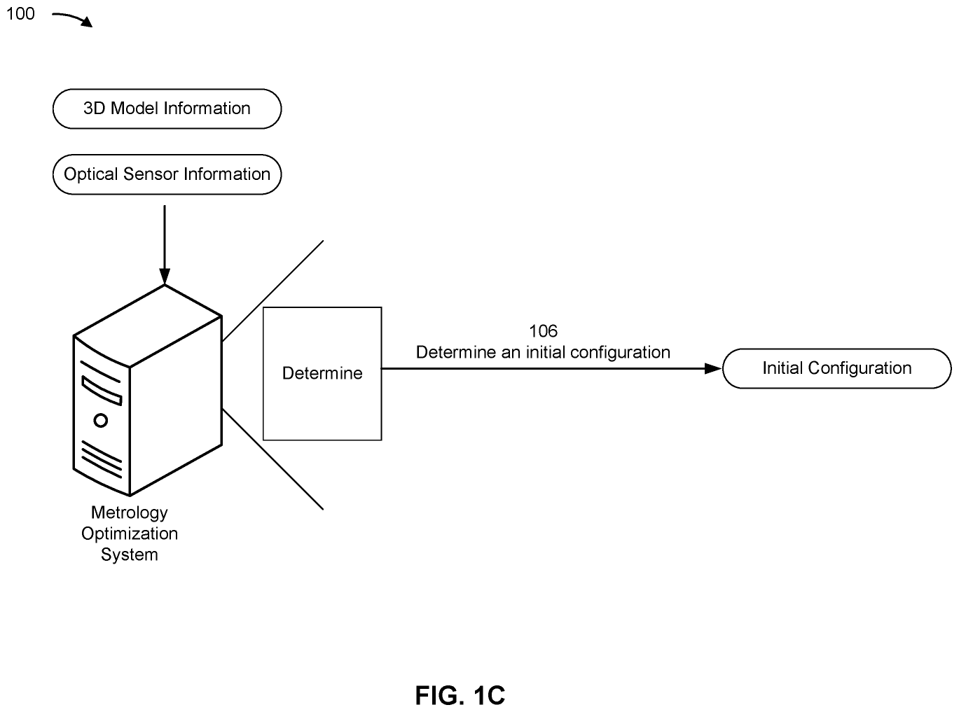

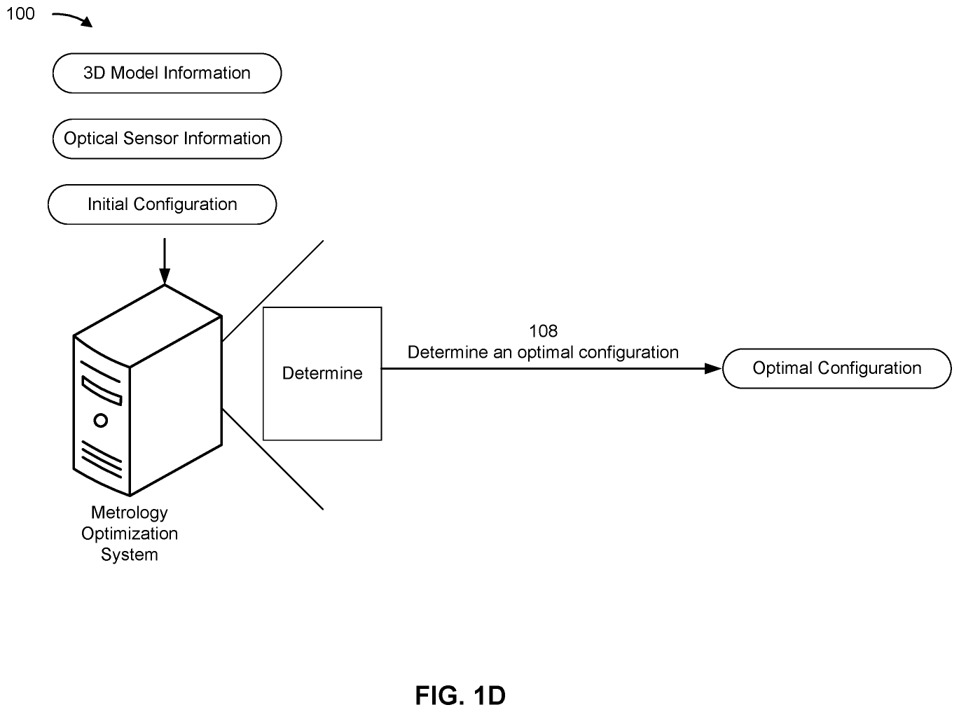

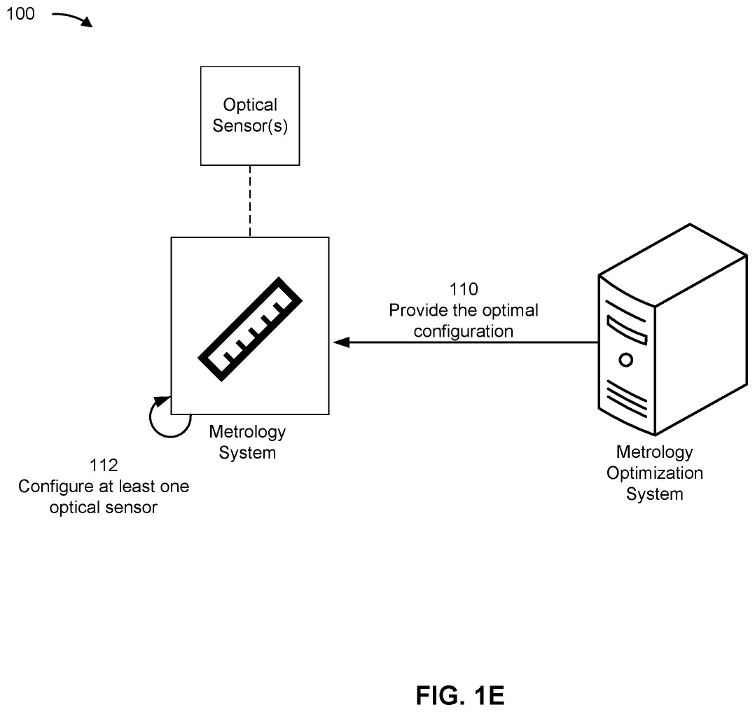

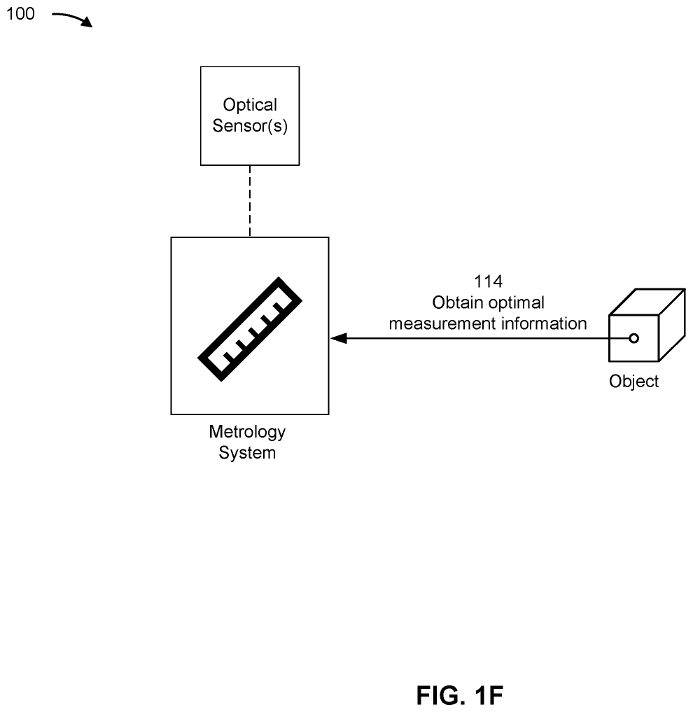

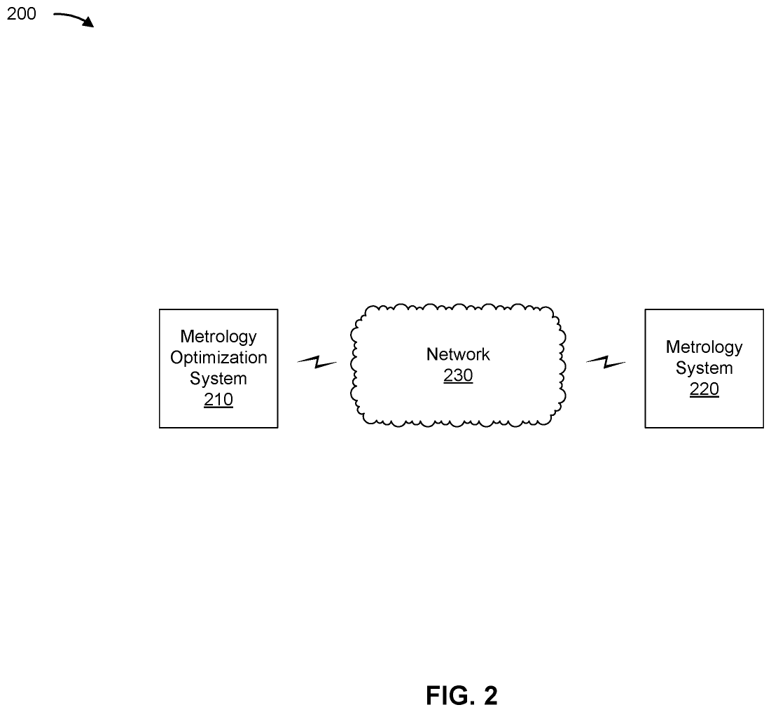

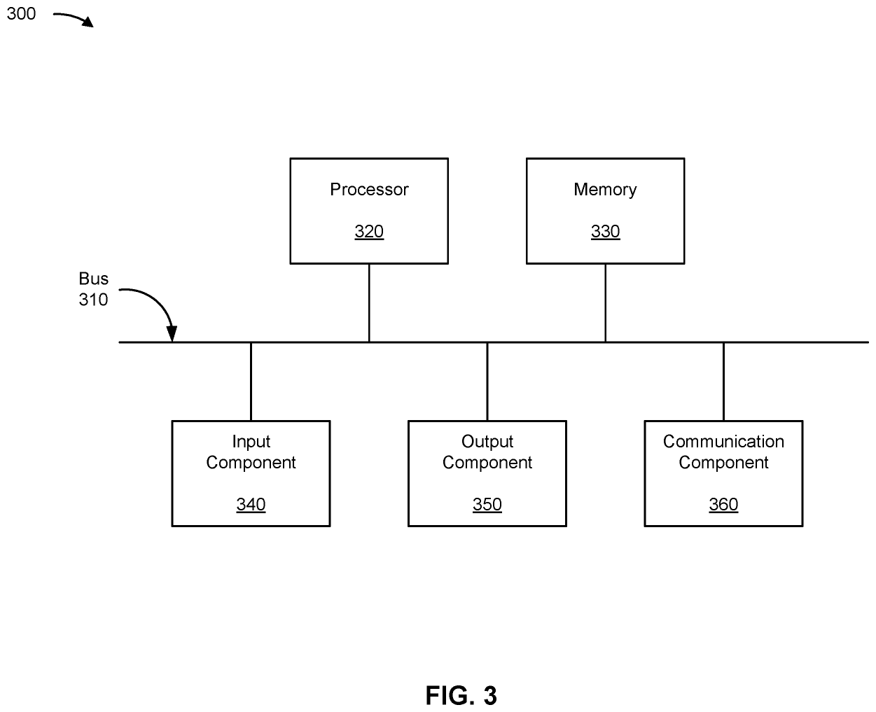

FIGS. 1A-1F are diagrams of an example implementation 100 associated with determining an optimal configuration for a metrology system. As shown in FIGS. 1A-1F, example implementation 100 includes a metrology optimization system and a metrology system. These devices are described in more detail below in connection with FIG. 2 and FIG. 3.

The metrology system may be used to measure an object (shown in FIGS. 1A and 1F) (e.g., measure a geometry of the object). The metrology system may be configured to include, for example, one or more optical sensors, such as one or more phase-based multi-tone continuous wave (PB-MTCW) optical sensors or one or more optical sensors associated with LiDAR (Light Detection and Ranging), photogrammetry, or other three dimensional (3D) optical sensing technologies. The metrology system may include a frame, or other type of physical structure, on which each of the one or more optical sensors is to be disposed (e.g., each of the one or more optical sensors is to be mounted on the frame). Accordingly, per a configuration of the metrology system, each optical sensor may be made to have a particular position and a particular orientation to enable measurement of the object (e.g., each optical sensor may be positioned and oriented to measure one or more surfaces of the object). The metrology optimization system may determine an optimal configuration for the metrology system, as further described herein.

As shown in FIG. 1A, and by reference number 102, the metrology optimization system may obtain 3D model information associated with the object. The 3D model information, for example, may indicate geometric information related to one or more components of the object (e.g., the 3D model information may indicate a respective geometry of the one or more components); interface information related to one or more components of the object (e.g., the interface information may indicate how the one or more components contact each other, such as via a flush interface, an angled interface, an offset interface, or another type of interface); material information related to one or more components of the object (e.g., the material information may indicate one or more materials of the one or more components, such as a metal material, an organic material, a polymer material, or another type of material); and/or feature information related to one or more components of the object (e.g., the feature information may indicate features of the one or more components, such as a handle, an alignment element, or another type of feature of the one or more components). In some implementations, the 3D model information includes a computer-aided design (CAD) model of the object, or another type of model of the object.

In some implementations, the metrology optimization system may receive the 3D model information. For example, the metrology system, or another source (e.g., a server device or a data source) may send the 3D model information to the metrology optimization system, which allows the metrology optimization system to receive the 3D model information. Alternatively, the metrology optimization system may receive initial measurement information associated with the object, and may determine, based on the initial measurement information, the 3D model information (e.g., by processing the initial measurement information). For example, the metrology system may perform (e.g., when the object is an “unknown” object) an initial measurement of the object (e.g., using an initial configuration of the metrology system) to generate the initial measurement information associated with the object (e.g., that indicates a “coarse”, or non-optimized, measurement of the geometry of the object). The metrology system may send the initial measurement information to the metrology optimization system, and the metrology optimization system may thereby determine (e.g., using one or more processing and/or analysis techniques) the 3D model information.

As shown in FIG. 1B, and by reference number 104, the metrology optimization system may obtain optical sensor information associated with the metrology system. The optical sensor information, for example, may indicate, for each optical sensor of the metrology system, an FOV of the optical sensor (e.g., an angular extent of a scene that the optical sensor can capture), a setback range of the optical sensor (e.g., a range of distances at which the optical sensor can reliably measure an object in a scene), a modulation frequency range of the optical sensor (e.g., a range of frequencies over which one or more optical signals of the optical sensor can be modulated), a power level range of the optical sensor (e.g., a range of optical power levels that the optical sensor can operate within), a point density and point distribution of the optical sensor (e.g., respective sizes and positions of points of the optical sensor), a measurement path within the FOV of the optical sensor (e.g., a point-by-point path for measuring points of the optical sensor, such as a raster path), and/or an integration time range of the optical sensor (e.g., a range of durations for which the optical sensor can collect light before converting the light into an electrical signal). In some implementations, the metrology optimization system may receive the optical sensor information. For example, the metrology system, or another source (e.g., a server device or a data source) may send the optical sensor information to the metrology optimization system, which allows the metrology optimization system to receive the optical sensor information.

As shown in FIG. 1C, and by reference number 106, the metrology optimization system may determine an initial configuration for the metrology system (e.g., based on the 3D model information and/or the optical sensor information). The initial configuration, for example, may indicate, for each optical sensor of the metrology system, an initial position of the optical sensor relative to a surface of the object (e.g., an initial distance between the optical sensor and the surface of the object and/or an initial distance offset from a midpoint, or another point, of the surface of the object); an initial orientation of the optical sensor relative to the surface of the object (e.g., an initial angle or direction at which the optical sensor is pointed at the surface of the object); and/or an initial integration time for each point of an FOV of the optical sensor (e.g., an initial duration for which the optical sensor collects light from each point of the FOV). The initial configuration may be a default configuration of the metrology system, or may be another type of configuration of the metrology system (e.g., a most recently used configuration of the metrology system).

In some implementations, the metrology optimization system may process the 3D model information and/or the optical sensor information to determine the initial configuration. As an example, such as when the object has a “cubic” geometry (e.g., that includes six surfaces), such as shown in FIG. 1A and FIG. 1F, the metrology optimization system may process the 3D model information to identify the surfaces of the object. The metrology optimization system then may identify a number of optical sensors to include in the metrology system (e.g., one optical sensor per surface of the object). Further, the metrology optimization system may process the optical sensor information to determine where each optical sensor is to be positioned and oriented relative to a surface of the object, and to determine a particular integration time (e.g., a same “default” integration time) for each point in the FOV of the optical sensor. Accordingly, the metrology optimization system may determine the initial configuration as a configuration which enables the metrology system to obtain a measurement of each surface of the object.

As shown in FIG. 1D, and by reference number 108, the metrology optimization system may determine an optimal configuration for the metrology system (e.g., based on the 3D model information, the optical sensor information, and/or the initial configuration). The optimal configuration, for example, may indicate, for each optical sensor of the metrology system, an optimal position of the optical sensor relative to a surface of the object (e.g., an optimal distance between the optical sensor and the surface of the object and/or an optimal distance offset from a midpoint, or another point, of the surface of the object); an optimal orientation of the optical sensor relative to the surface of the object (e.g., an optimal angle or direction at which the optical sensor is pointed at the surface of the object); and/or an optimal integration time for each point of an FOV of the optical sensor (e.g., an optimal duration for which the optical sensor collects light from each point of the FOV). The optimal configuration may be optimal with respect to minimizing a number of optical sensors used to measure the object, to minimizing a total amount of time for the optical sensors to measure the object, to increasing accuracy associated with measuring the object, to increasing a comprehensiveness of measuring the object, and/or to decreasing an amount of data captured to measure the object, among other examples. In some implementations, the optimal configuration may include a fewer number of optical sensors than the number of optical sensors included in the initial configuration (e.g., because, in the optimal configuration, an optical sensor may be able to efficiently and accurately measure more than one surface of the object), or, alternatively, may include a greater number of optical sensors than the number of optical sensors included in the initial configuration (e.g., because, in the optimal configuration, more than one optical sensor may be needed to efficiently and accurately measure a surface of the object). Further, an optical sensor in the optical configuration that corresponds to an optical sensor in the initial configuration (e.g., each optical sensor is to measure a same surface of the object) may have a different position, a different optimal orientation, and/or a different integration time for at least one point of the FOV of the optical sensor.

In some implementations, the metrology optimization system may process the 3D model information, the optical sensor information, and/or the initial configuration to determine the optimal configuration. For example, the metrology optimization system may process the 3D model information, the optical sensor information, and/or the initial configuration to determine the optimal configuration using one or more optimization techniques to determine the optimal configuration.

As an example, the metrology optimization system may determine (e.g., using one or more simulation techniques), based on the 3D model information, the optical sensor information, and the initial configuration, respective initial signal-to-noise (SNR) scores for one or more regions of a surface of the object (e.g., where each region of the surface of the object is associated with a corresponding point of an FOV of an optical sensor of the metrology system that has an initial position and an initial orientation relative to the surface of the object). Further, the metrology optimization system may determine (e.g., using one or more simulation techniques), based on the 3D model information and the optical sensor information, a set of one or more other SNR scores for each region of the one or more regions of the surface of the object (e.g., where each other SNR score, of the set of one or more other SNR scores, is associated with at least one of a particular other position or a particular other orientation of the optical sensor relative to the surface of the object). Accordingly, the metrology optimization system may determine, based on the respective initial SNR scores for the one or more regions of the surface of the object and the set of one or more other SNR scores for each region of the one or more regions of the surface of the object, the optimal configuration. That is, the metrology optimization system may determine an optimal number of optical sensors for the surface of the object, an optimal position and optimal orientation of each optical sensor relative to the surface of the object, and/or an optimal integration for each point of an FOV of each optical sensor. Accordingly, the metrology optimization system may perform one or more similar operations with respect to each side of the object and/or with respect to the object as whole to determine the optimal configuration.

As shown in FIG. 1E, and by reference number 110, the metrology optimization system may provide the optimal configuration. For example, the metrology optimization system may send the optimal configuration to the metrology system. As shown by reference number 112, this may allow the metrology system to configure at least one optical sensor of the metrology system (e.g., according to the optimal configuration). For example, the metrology system may cause, based on the optimal configuration, an optical sensor of the metrology system to have at least one of: a particular position relative to the frame of the metrology system, a particular orientation relative to the frame of the metrology system, and/or a particular integration time for each point of an FOV of the optical sensor. In this way, the optical sensor may be configured to comprehensively, to accurately, and to efficiently measure the object (e.g., at least some of one or more surfaces of the object), such as when the object is positioned to be measured by the metrology system.

Accordingly, as shown in FIG. 1F and by reference number 114, the metrology system may obtain optimal measurement information associated with the object. That is, because the metrology system is configured according to the optimal configuration, the metrology system may measure the object using one or more optical sensors that are configured according to the optimal configuration. The metrology system therefore obtains optimal measurement information.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram of an example environment 200 in which systems and/or methods described herein may be implemented. As shown in FIG. 2, environment 200 may include a metrology optimization system 210, a metrology system 220, and/or a network 230. Devices of environment 200 may interconnect via wired connections, wireless connections, or a combination of wired and wireless connections.

The metrology optimization system 210 may include one or more devices capable of receiving, generating, storing, processing, and/or providing information associated with determining an optimal configuration for a metrology system (e.g., the metrology system 220), as described elsewhere herein. The metrology optimization system 210 may include a communication device and/or a computing device. For example, the metrology optimization system 210 may include a server, such as an application server, a client server, a web server, a database server, a host server, a proxy server, a virtual server (e.g., executing on computing hardware), or a server in a cloud computing system. In some implementations, the metrology optimization system 210 may include computing hardware used in a cloud computing environment. As another example, the metrology optimization system 210 may include a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The metrology system 220 may include one or more devices capable of receiving, generating, storing, processing, and/or providing information as described elsewhere herein. The metrology system 220 may include one or more optimal sensors and may be configured to measure an object (e.g., by obtaining measurement information), as described herein. The metrology system may be configured to communicate with the metrology optimization system 210 (e.g., via the network 230), such as to provide 3D model information, optical sensor information, and/or a configuration to the metrology optimization system 210, as described herein.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with determining an optimal configuration for a metrology system. The device 300 may correspond to the metrology optimization system 210 and/or the metrology system 220. In some implementations, the metrology optimization system 210 and/or the metrology system 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

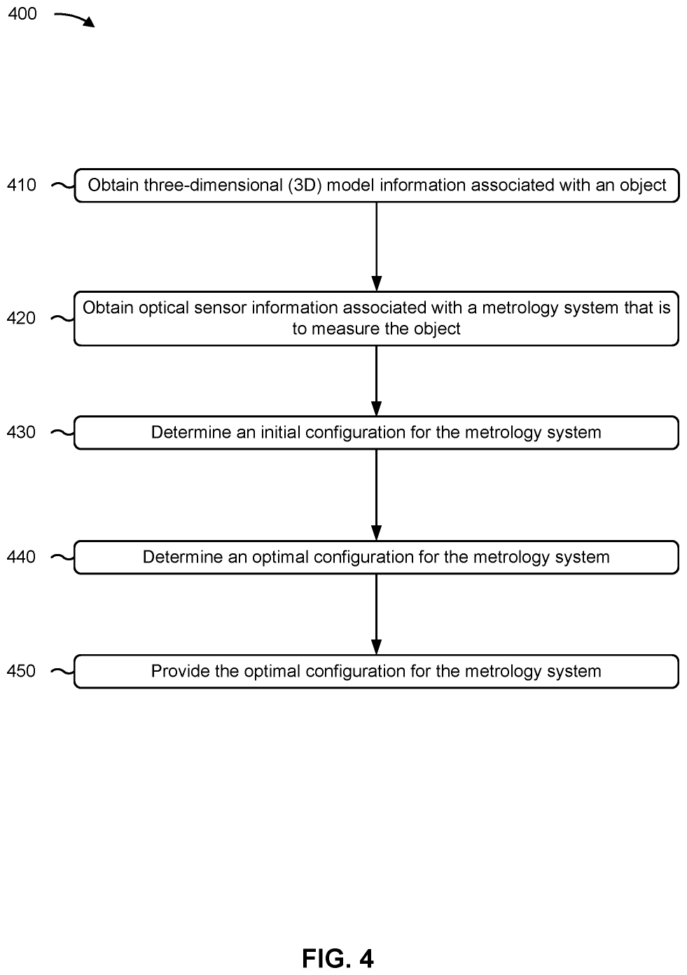

FIG. 4 is a flowchart of an example process 400 associated with determining an optimal configuration for a metrology system. In some implementations, one or more process blocks of FIG. 4 are performed by a metrology optimization system (e.g., the metrology optimization system 210). In some implementations, one or more process blocks of FIG. 4 are performed by another device or a group of devices separate from or including the metrology optimization system, such as a metrology system (e.g., the metrology system 220). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include obtaining 3D model information associated with an object (block 410). For example, the metrology optimization system may obtain 3D model information associated with an object, as described above.

As further shown in FIG. 4, process 400 may include obtaining optical sensor information associated with a metrology system that is to measure the object (block 420). For example, the metrology optimization system may obtain optical sensor information associated with a metrology system that is to measure the object, as described above.

As further shown in FIG. 4, process 400 may include determining an initial configuration for the metrology system (block 430). For example, the metrology optimization system may determine, based on the 3D model information and the optical sensor information, an initial configuration for the metrology system, as described above.

As further shown in FIG. 4, process 400 may include determining an optimal configuration for the metrology system (block 440). For example, the metrology optimization system may determine, based on the 3D model information, the optical sensor information, and the initial configuration, an optimal configuration for the metrology system, as described above.

As further shown in FIG. 4, process 400 may include providing the optimal configuration for the metrology system (block 450). For example, the metrology optimization system may provide the optimal configuration for the metrology system, as described above.

Process 400 may include additional implementations, such as any single implementation or any combination of implementations described below and/or in connection with one or more other processes described elsewhere herein.

In a first implementation, the 3D model information includes a CAD model of the object.

In a second implementation, alone or in combination with the first implementation, obtaining the 3D model information comprises receiving, from the metrology system, initial measurement information associated with the object, and determining, based on the initial measurement information, the 3D model information.

In a third implementation, alone or in combination with one or more of the first and second implementations, the 3D model information indicates at least one of: geometric information related to one or more components of the object, interfacing information related to one or more components of the object, material information related to one or more components of the object, or featuring information related to one or more components of the object.

In a fourth implementation, alone or in combination with one or more of the first through third implementations, the optical sensor information indicates, for each optical sensor of the metrology system, at least one of: an FOV of the optical sensor, a setback range of the optical sensor, a modulation frequency range of the optical sensor, a power level range of the optical sensor, a point density and point distribution of the optical sensor, a measurement path within the FOV of the optical sensor, or an integration time range of the optical sensor.

In a fifth implementation, alone or in combination with one or more of the first through fourth implementations, the initial configuration indicates, for each optical sensor of the metrology system, at least one of: an initial position of the optical sensor relative to a surface of the object, an initial orientation of the optical sensor relative to the surface of the object, or an initial integration time for each point of an FOV of the optical sensor.

In a sixth implementation, alone or in combination with one or more of the first through fifth implementations, the optimal configuration indicates, for each optical sensor of the metrology system, at least one of: an optimal position of the optical sensor relative to a surface of the object, an optimal orientation of the optical sensor relative to the surface of the object, or an optimal integration time for each point of an FOV of the optical sensor.

In a seventh implementation, alone or in combination with one or more of the first through sixth implementations, determining the optimal configuration comprises determining, based on the 3D model information, the optical sensor information, and the initial configuration, respective initial SNR scores for one or more regions of a surface of the object, wherein each region of the surface of the object is associated with a corresponding point of an FOV of an optical sensor of the metrology system that has an initial position and an initial orientation relative to the surface of the object, determining, based on the 3D model information and the optical sensor information, a set of one or more other SNR scores for each region of the one or more regions of the surface of the object, wherein each other SNR score, of the set of one or more other SNR scores, is associated with at least one of a particular other position or a particular other orientation of the optical sensor relative to the surface of the object, and determining, based on the respective initial SNR scores for the one or more regions of the surface of the object and the set of one or more other SNR scores for each region of the one or more regions of the surface of the object, the optimal configuration.

In an eighth implementation, alone or in combination with one or more of the first through seventh implementations, providing the optimal configuration comprises sending the optimal configuration to the metrology system, wherein sending the optimal configuration to the metrology system allows the metrology system to cause an optical sensor of the metrology system to be configured to have at least one of: a particular position relative to a frame of the metrology system, a particular orientation relative to the frame of the metrology system, or a particular integration time for each point of an FOV of the optical sensor.

In a ninth implementation, alone or in combination with one or more of the first through eighth implementations, providing the optimal configuration comprises sending the optimal configuration to the metrology system, wherein sending the optimal configuration to the metrology system allows the metrology system to obtain optimal measurement information associated with the object.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a processor or one or more processors) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining, by a metrology optimization system, three-dimensional (3D) model information associated with an object;
obtaining, by the metrology optimization system, optical sensor information associated with a metrology system that is to measure the object;
determining, by the metrology optimization system and based on the 3D model information and the optical sensor information, an initial configuration for the metrology system;
determining, by the metrology optimization system and based on the 3D model information, the optical sensor information, and the initial configuration, an optimal configuration for the metrology system; and
providing, by the metrology optimization system, the optimal configuration for the metrology system.

2. The method of claim 1, wherein the 3D model information includes a computer-aided design (CAD) model of the object.

3. The method of claim 1, wherein obtaining the 3D model information comprises:
receiving, from the metrology system, initial measurement information associated with the object; and
determining, based on the initial measurement information, the 3D model information.

4. The method of claim 1, wherein the 3D model information indicates at least one of:
geometric information related to one or more components of the object;
interface information related to one or more components of the object;
material information related to one or more components of the object; or
feature information related to one or more components of the object.

5. The method of claim 1, wherein the optical sensor information indicates, for each optical sensor of the metrology system, at least one of:
a field of view (FOV) of the optical sensor;
a setback range of the optical sensor;
a modulation frequency range of the optical sensor;
a power level range of the optical sensor;
a point density and point distribution of the optical sensor;
a measurement path within the FOV of the optical sensor; or
an integration time range of the optical sensor.

6. The method of claim 1, wherein the initial configuration indicates, for each optical sensor of the metrology system, at least one of:
an initial position of the optical sensor relative to a surface of the object;
an initial orientation of the optical sensor relative to the surface of the object; or
an initial integration time for each point of a field of view (FOV) of the optical sensor.

7. The method of claim 1, wherein the optimal configuration indicates, for each optical sensor of the metrology system, at least one of:
an optimal position of the optical sensor relative to a surface of the object;
an optimal orientation of the optical sensor relative to the surface of the object; or
an optimal integration time for each point of a field of view (FOV) of the optical sensor.

8. The method of claim 1, wherein determining the optimal configuration comprises:
determining, based on the 3D model information, the optical sensor information, and the initial configuration, respective initial signal-to-noise (SNR) scores for one or more regions of a surface of the object,
wherein each region of the surface of the object is associated with a corresponding point of a field of view (FOV) of an optical sensor of the metrology system that has an initial position and an initial orientation relative to the surface of the object;
determining, based on the 3D model information and the optical sensor information, a set of one or more other SNR scores for each region of the one or more regions of the surface of the object,
wherein each other SNR score, of the set of one or more other SNR scores, is associated with at least one of a particular other position or a particular other orientation of the optical sensor relative to the surface of the object; and
determining, based on the respective initial SNR scores for the one or more regions of the surface of the object and the set of one or more other SNR scores for each region of the one or more regions of the surface of the object, the optimal configuration.

9. The method of claim 1, wherein providing the optimal configuration comprises:
sending the optimal configuration to the metrology system,
wherein sending the optimal configuration to the metrology system allows the metrology system to cause an optical sensor of the metrology system to be configured to have at least one of:
a particular position relative to a frame of the metrology system;
a particular orientation relative to the frame of the metrology system; or
a particular integration time for each point of a field of view (FOV) of the optical sensor.

10. The method of claim 1, wherein providing the optimal configuration comprises:
sending the optimal configuration to the metrology system,
wherein sending the optimal configuration to the metrology system allows the metrology system to obtain optimal measurement information associated with the object.

11. A metrology optimization system, comprising:
one or more memories; and
one or more processors, coupled to the one or more memories, configured to:
determine, based on three-dimensional (3D) model information associated with an object and optical sensor information associated with a metrology system that is to measure the object, an initial configuration for the metrology system;
determine, based on the 3D model information, the optical sensor information, and the initial configuration, an optimal configuration for the metrology system; and
provide the optimal configuration for the metrology system.

12. The metrology optimization system of claim 11, wherein the one or more processors are further configured to:
receive, from the metrology system, the optical sensor information.

13. The metrology optimization system of claim 11, wherein the one or more processors are further configured to:
receive, from the metrology system, initial measurement information associated with the object; and
determine, based on the initial measurement information, the 3D model information.

14. The metrology optimization system of claim 11, wherein the optimal configuration indicates, for each optical sensor of the metrology system, at least one of:
an optimal position of the optical sensor relative to a surface of the object;
an optimal orientation of the optical sensor relative to the surface of the object; or
an optimal integration time for each point of a field of view (FOV) of the optical sensor.

15. The metrology optimization system of claim 11, wherein the one or more processors, to determine the optimal configuration, are configured to:
determine, based on the 3D model information, the optical sensor information, and the initial configuration, respective initial signal-to-noise (SNR) scores for one or more regions of a surface of the object,
wherein each region of the surface of the object is associated with a corresponding point of a field of view (FOV) of an optical sensor of the metrology system that has an initial position and an initial orientation relative to the surface of the object;
determine, based on the 3D model information and the optical sensor information, a set of one or more other SNR scores for each region of the one or more regions of the surface of the object,
wherein each other SNR score, of the set of one or more other SNR scores, is associated with at least one of a particular other position or a particular other orientation of the optical sensor relative to the surface of the object; and
determine, based on the respective initial SNR scores for the one or more regions of the surface of the object and the set of one or more other SNR scores for each region of the one or more regions of the surface of the object, the optimal configuration.

16. The metrology optimization system of claim 11, wherein the one or more processors, to provide the optimal configuration, are configured to:
send the optimal configuration to the metrology system,
wherein sending the optimal configuration to the metrology system allows the metrology system to cause an optical sensor of the metrology system to be configured to have at least one of:
a particular position relative to a frame of the metrology system;
a particular orientation relative to the frame of the metrology system; or
a particular integration time for each point of a field of view (FOV) of the optical sensor.

17. A non-transitory computer-readable medium storing a set of instructions, the set of instructions comprising:
one or more instructions that, when executed by one or more processors of a metrology optimization system, cause the metrology optimization system to:
determine, based on three-dimensional (3D) model information associated with an object and optical sensor information associated with a metrology system that is to measure the object, an optimal configuration for the metrology system; and
provide the optimal configuration for the metrology system.

18. The non-transitory computer-readable medium of claim 17, wherein the one or more instructions, that cause the metrology optimization system to determine the optimal configuration, cause the metrology optimization system to:
determine, based on the 3D model information and the optical sensor information, respective initial signal-to-noise (SNR) scores for one or more regions of a surface of the object,
wherein each region of the surface of the object is associated with a corresponding point of a field of view (FOV) of an optical sensor of the metrology system that has an initial position and an initial orientation relative to the surface of the object;
determine, based on the 3D model information and the optical sensor information, a set of one or more other SNR scores for each region of the one or more regions of the surface of the object,
wherein each other SNR score, of the set of one or more other SNR scores, is associated with at least one of a particular other position or a particular other orientation of the optical sensor relative to the surface of the object; and
determine, based on the respective initial SNR scores for the one or more regions of the surface of the object and the set of one or more other SNR scores for each region of the one or more regions of the surface of the object, the optimal configuration.

19. The non-transitory computer-readable medium of claim 17, wherein the one or more instructions, that cause the metrology optimization system to provide the optimal configuration, cause the metrology optimization system to:
send the optimal configuration to the metrology system to allow the metrology system to cause an optical sensor of the metrology system to be configured according to the optimal configuration.

20. The non-transitory computer-readable medium of claim 17, wherein the one or more instructions, that cause the metrology optimization system to provide the optimal configuration, cause the metrology optimization system to:
send the optimal configuration to the metrology system to allow the metrology system to obtain optimal measurement information associated with the object.
